(19) United States
(12) Patent Application Publication
(10) Pub. No.: US 2011/0100304 A1
(43) Pub. Date: May 5, 2011

(54) ANIMAL EXERCISE APPARATUS AND METHOD OF MANUFACTURE

(76) Inventor: Ellen Tsuyuki, White Rock (CA)

(21) Appl. No.: 12/610,136

(22) Filed: Oct. 30, 2009

(51) Int. Cl. A01K 15/02

(52) U.S. Cl. 119/707

(57) ABSTRACT

The present invention teaches an apparatus for exercising animals 20, having a body 24 and a spine 22, wherein the spine 22 includes an elongated member 26 with a protuberant head end 28 and an opposing protuberant tail end 30, the ends 28, 30 being adapted to retain the body 24 on the elongated member 26.

### BACKGROUND OF THE INVENTION

1. Field of the Invention

The present invention is directed to devices for exercising animals, and in particular to devices that cats chase and catch. Such devices typically include plush furred or feathered bodies towable on a string to represent small animals that a cat might encounter outdoors.

2. Description of Related Art

Devices for exercising animals must be constructed so as to interest the animal and to survive rough play without injuring the animal.

Such devices often include a small plush body that can be pursued and captured by an animal. Often, the body is connected to a string so that it can be scurried away from the animal to enhance play.

One weakness in conventional devices is the manner in which the string is connected to the plush body. Often, the string is simply tied around a portion of the body or else is knotted and/or sewn inside the body. Sometimes a small wire eyelet is sewn to the body and the string is threaded through the eyelet. In play the string or the connection can break quite quickly, such that a new method of connection must be jury-rigged or else play thereafter takes the form of leaving the body static or throwing the body. There is also a worry that the connection hardware will pose a choking or a cutting hazard.

Another limitation of conventional devices is that they are typically built as a skin over a stuffing material. In rough play, the skin tends to be torn and the stuffing tends to escape. Once again, breakaway bits pose a choking hazard.

What is needed is a more robust device.

### SUMMARY OF THE INVENTION AND ADVANTAGES

The present invention is directed to this need.

According to one aspect of the present invention, there is provided an apparatus for exercising animals comprising: a body, and a spine, wherein the spine includes an elongated member with a protuberant head end and an opposing protuberant tail end, the ends being adapted to retain the body on the elongated member. The body may be cinched onto the elongated member or wound onto the elongated member, for example.

The elongated member may be substantially flat, to resist rotation of the body. The elongated member may be rigid and formed from metal, preferably rust-resistant.

The ends may have a rounded perimeter, to avoid presenting sharp edges to the animal. The head end may form a coupler adapted to engage a string, for example a ring.

The spine may be articulated, for example constructed as an articulated member articulated with the elongated member, perhaps articulated at the coupler of the elongated member.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a plan view of one embodiment of an elongated member forming part of a spine for an apparatus for exercising animals according to the present invention.

FIG. 2 is a cross-sectional view of the elongated member of FIG. 1.

FIG. 3 is photograph of a first embodiment of a body retained on the spine of FIG. 1, the body representing a bug.

FIG. 4 is a photograph of a second embodiment of a body retained on the spine of FIG. 1, the body representing a winged bug.

FIG. 5 is photograph of a third embodiment of a body retained on the spine of FIG. 1, the body representing a winged bug with feathers.

FIG. 6 is photograph of a fourth embodiment of a body retained on the spine of FIG. 1, the body representing a small rodent with a tail.

FIG. 7 is photograph of a fifth embodiment of a body retained on the spine of FIG. 1, the body representing a rodent with an articulated body.

### DETAILED DESCRIPTION OF THE INVENTION

Referring to the Figures, wherein like numerals indicate corresponding parts throughout the several views, an apparatus for exercising animals 20 is generally built as a spine 22 supporting a body 24.

The Spine 22

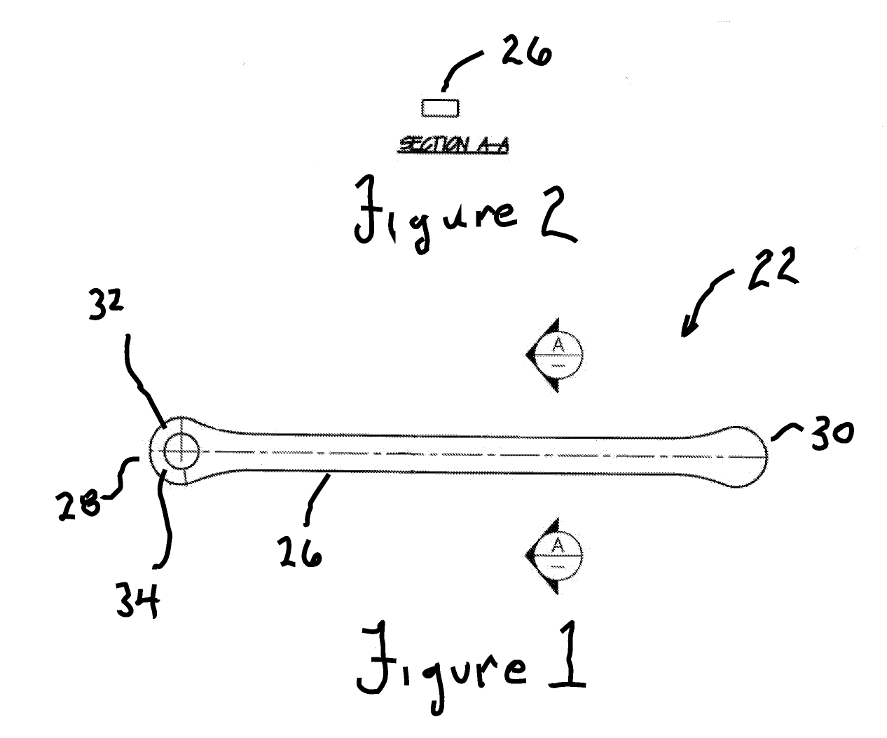

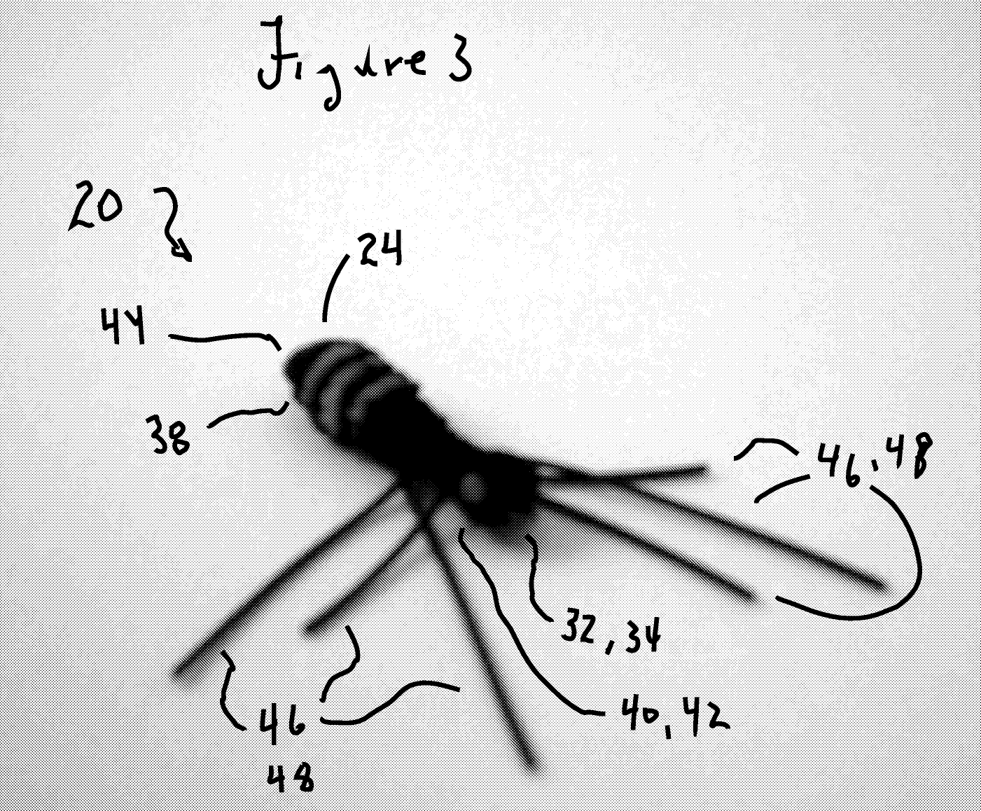

FIGS. 1 and 2 illustrate one embodiment of the spine 22, which includes an elongated member 26 with a protuberant head end 28 and an opposing protuberant tail end 30, the ends 28, 30 being adapted to retain the body 24 on the elongated member 26.

In this embodiment, the elongated member 26 is substantially flat to resist rotation of the body 24. The ends 28, 30 have a rounded perimeter so that they will not present sharp edges to the animal should they project beyond the body 24.

The head end 28 forms a coupler 32 adapted to engage a string S (not part of the invention). In the embodiment illustrated, the coupler 32 defines a ring 34; however, other configurations will easily occur to those skilled in the art, including complementary couplers 32.

In this embodiment, the elongated member 26 is rigid to more robustly retain the body 24. In this regard, the elongated member 26 might be formed from metal, and preferably rust-resistant.

The spine 22 may be formed in an articulated fashion. An articulated member 36, for example similar or identical to the elongated member 26, can be articulated with the elongated member 26, conveniently at the preexisting coupler 32, for example.

The Body 24

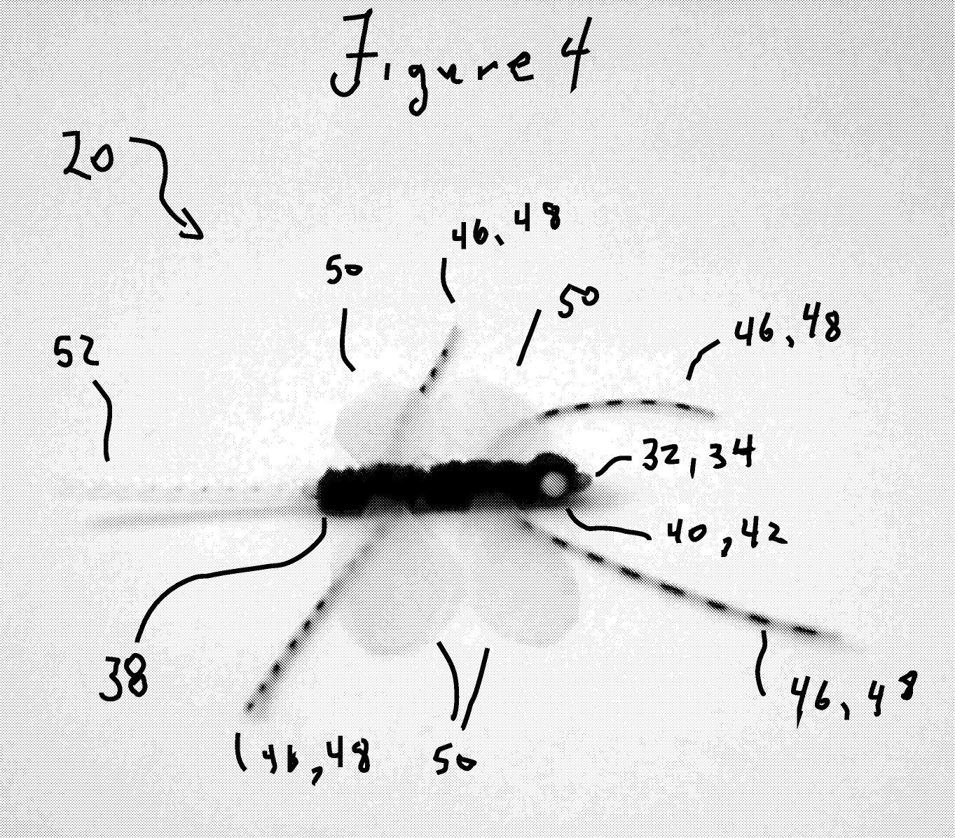

FIG. 3 illustrates a first embodiment of the apparatus for exercising animals 20, resembling a bug. In general, the body 24 is formed from windings 38 of thread, yarn, twine, pipe cleaner, or the like wound around the spine 22—thicker in some places, thinner in others—to accrete a bug shape. Different colors of windings 38 can be used together to produce typical bug patterns, for example stripes. Beads 40 can be threaded onto a winding 38 to represent eyes 42. Other materials can be trapped under the windings 38 to produce desired effects. For example, resilient spacers 44 such as strips of foam can be sandwiched between the spine 22 and the windings 38 to provide volume and yield and to help retain the windings 38 on the elongated member 26. As another example, elastic segments 46 can be trapped at their midpoint between windings 38, their ends 28, 30 free to wiggle, representing a pair of legs 48.

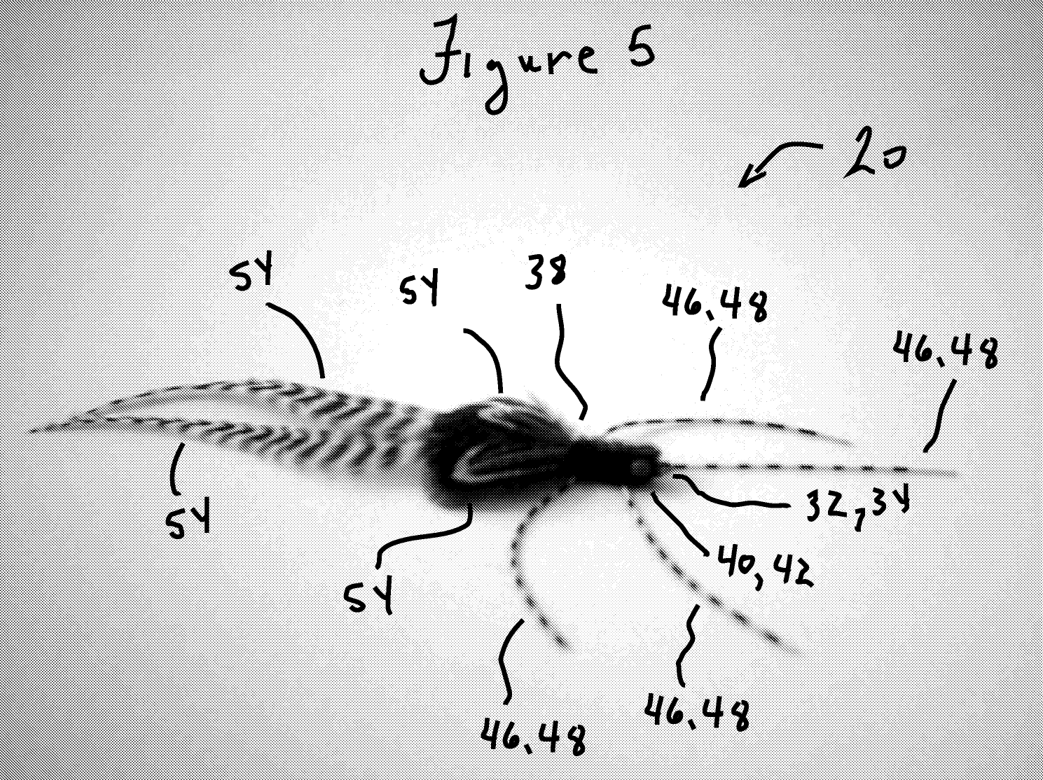

FIG. 4 illustrates a second embodiment of the apparatus for exercising animals 20, resembling a winged bug. The second embodiment is constructed quite similarly to the first embodiment; however, the second embodiment also includes pairs of iridescent plastic wings 50 mounted between windings 38 in much the same way as legs 48 are. There is also a tubular tail 52 having one end that envelops the spine 22 and that is cinched to the spine 22 by the windings 38.

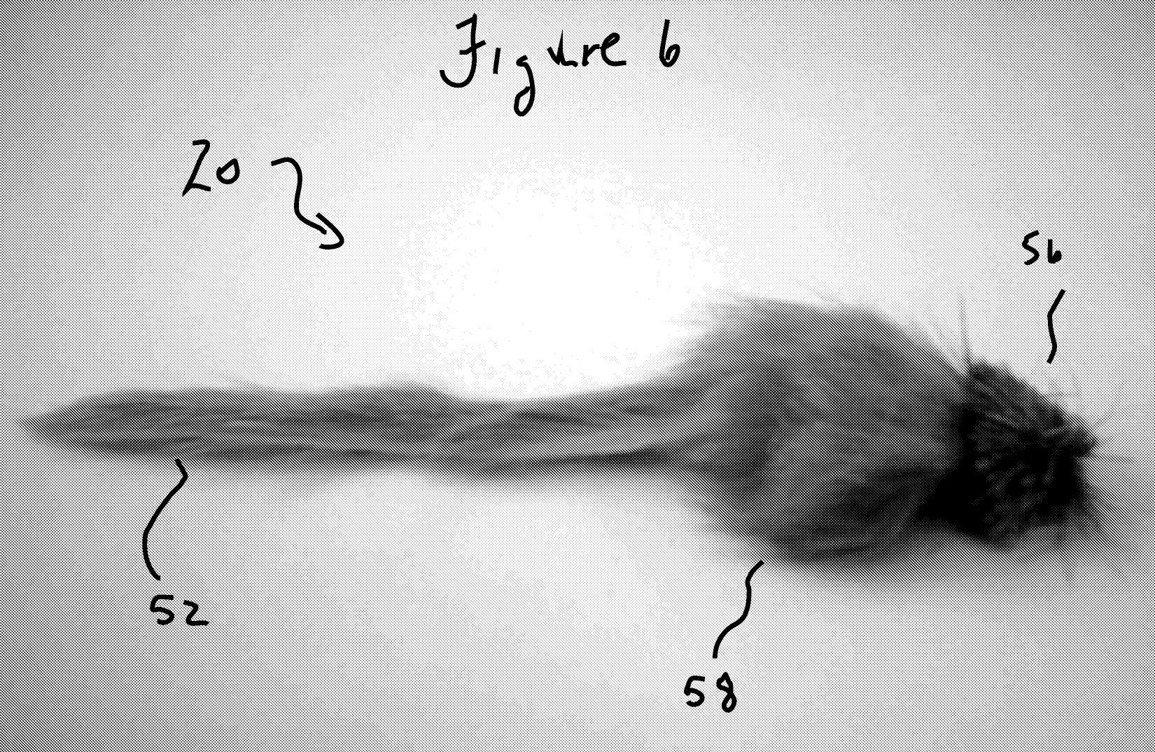

FIG. 5 illustrates a third embodiment of the apparatus for exercising animals 20, resembling a winged bug with feathers 54. The third embodiment is constructed fairly similarly to the second and third embodiments. A feather 54 is attached to the body 24 by trapping its calamus in the windings 38, while leaving the rest of the rachis and the barbules free.

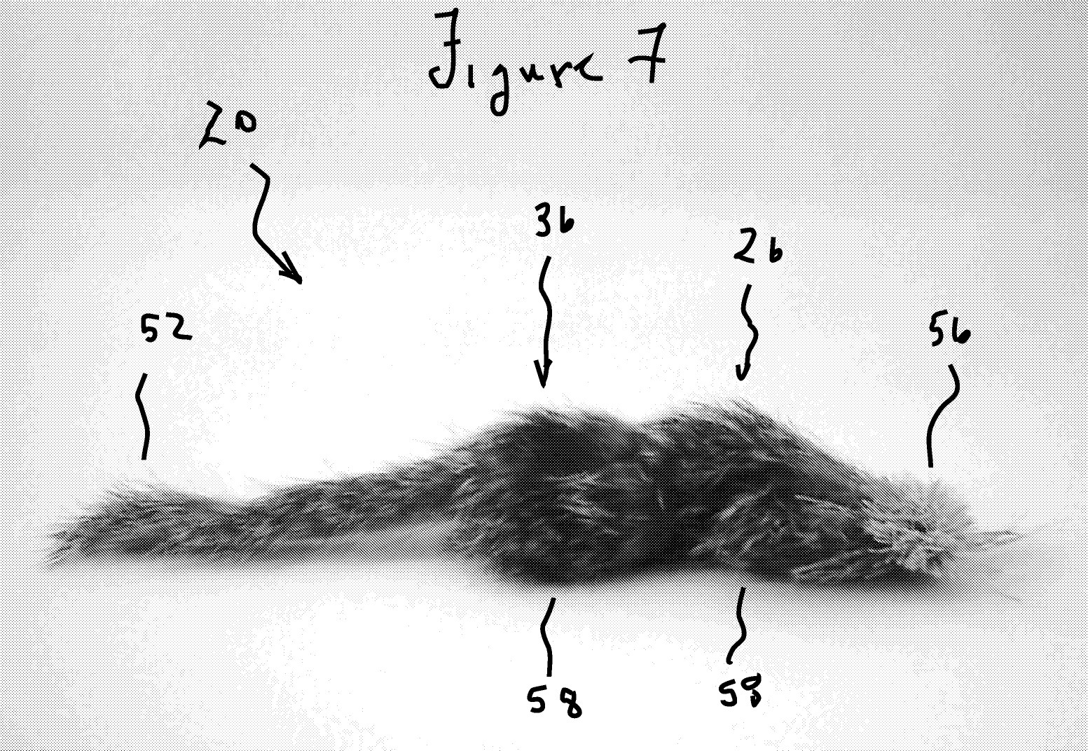

FIG. 6 illustrates a fourth embodiment of the apparatus for exercising animals 20, resembling a small rodent. A bundle of bristles 56, a fur cap 58 and a furry tail 52 have all been cinched to the spine 22 to form the body 24.

FIG. 7 illustrates a fifth embodiment of the apparatus for exercising animals 20, resembling a rodent with an articulated body 24. In this regard, the spine 22 is articulated as was described more fully above.

In operation, a user secures a string S to the apparatus 20 for exercising an animal at the coupler 32 and more particularly in this embodiment at the ring 34. The user then pulls the string S in such a way as to cause the apparatus 20 to move in a way representative of whatever the body 24 represents, for example bug, flying bug, or rodent. When an animal catches the body 24, it is well-supported by the spine 22 and retained on the elongated member 26 under the urging of the protuberant ends 28, 30. In this regard, the apparatus 20 is robust against breakaway bits that might pose a choking or cutting hazard. Furthermore, the rounded perimeter of the protuberant ends 28, 30 is less likely to injure the animal.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed is:

1. An apparatus for exercising animals (20) comprising:
a body (24), and
a spine (22), wherein said spine (22) includes an elongated member (26) with a protuberant head end (28) and an opposing protuberant tail end (30), said ends (28, 30) being adapted to retain said body (24) on said elongated member (26).

2. An apparatus for exercising animals (20), as set forth in claim 1 wherein said elongated member (26) is substantially flat.

3. An apparatus for exercising animals (20), as set forth in claim 2 wherein said ends (28, 30) have a rounded perimeter.

4. An apparatus for exercising animals (20), as set forth in claim 3 wherein said head end (28) forms a coupler (32) adapted to engage a string (S).

5. An apparatus for exercising animals (20), as set forth in claim 4 wherein said coupler (32) defines a ring (34).

6. An apparatus for exercising animals (20), as set forth in claim 5 wherein said elongated member (26) is rigid.

7. An apparatus for exercising animals (20), as set forth in claim 6 wherein said elongated member (26) is formed from metal.

8. An apparatus for exercising animals (20), as set forth in claim 7 wherein said elongated member (26) is rust-resistant.

9. An apparatus for exercising animals (20), as set forth in claim 5 wherein said body (24) is wound onto said elongated member (26).

10. An apparatus for exercising animals (20), as set forth in claim 5 wherein said body (24) is cinched onto said elongated member (26).

11. An apparatus for exercising animals (20), as set forth in claim 5 wherein said spine (22) is articulated.

12. An apparatus for exercising animals (20), as set forth in claim 11 wherein said spine (22) includes an articulated member (36) articulated with said elongated member (26).
An apparatus for exercising animals (20), as set forth in claim 12 wherein said articulated member (36) is articulated with said elongated member (26) at said coupler (32).
